(19) United States
(12) Patent Application Publication
(10) Pub. No.: US 2015/0042017 A1
(43) Pub. Date: Feb. 12, 2015

(54) THREE-DIMENSIONAL (3D) PROCESSING AND PRINTING WITH PLASMA SOURCES

(71) Applicant: APPLIED MATERIALS, INC., SANTA CLARA, CA (US)

(72) Inventors: Kartik RAMASWAMY, San Jose, CA (US); Troy DETRICK, Los Altos, CA (US); Srinivas NEMANI, Sunnyvale, CA (US); Ajey JOSHI, San Jose, CA (US)

(73) Assignee: APPLIED MATERIALS, INC., SANTA CLARA, CA (US)

(21) Appl. No.: 14/063,860

(22) Filed: Oct. 25, 2013

Related U.S. Application Data
(60) Provisional application No. 61/862,812, filed on Aug. 6, 2013.

(51) Int. Cl. B28B 1/00; C23C 26/02

(52) U.S. Cl. CPC B28B 1/001; C23C 26/02
USPC 264/446; 264/483; 425/174

(57) ABSTRACT

Embodiments include systems, apparatuses, and methods of three-dimensional plasma printing or processing. In one embodiment, a method includes introducing chemical precursors into one or more point plasma sources, generating plasma in the one or more point plasma sources from the chemical precursors with one or more power sources, and locally patterning a substrate disposed over a stage with the generated plasma by moving the stage with respect to the one or more point plasma sources.

### CROSS REFERENCE TO RELATED APPLICATION

This application claims the benefit of priority to U.S. Provisional Application No. 61/862,812 filed on Aug. 6, 2013, titled “THREE DIMENSIONAL (3D) PROCESSING AND PRINTING WITH PLASMA SOURCES,” the entire contents of which is hereby incorporated by reference in its entirety for all purposes.

### BACKGROUND

1) Field

Embodiments of the present invention pertain to the field of plasma processing and, in particular, to three-dimensional printing and processing with plasma sources.

2) Description of Related Art

Three-dimensional (3D) printing can be used to make 3D objects based on a digital model. Traditionally, a laser is used to melt a material, and the molten material is deposited on a surface according to the model. This process is repeated for multiple layers until the object of the digital model is created. Such a process is limited to deposition of particular materials which can be melted with a laser, and cannot achieve deposition of complex combinations of elements. The current technology using a laser to melt the material to be deposited is also limited in that the surface receiving the molten material and the molten material is roughly the same temperature.

### SUMMARY

One or more embodiments of the invention are directed to methods of three-dimensional plasma printing or processing.

In one embodiment, a method includes introducing chemical precursors into one or more point plasma sources. The method includes generating plasma in the one or more point plasma sources from the chemical precursors with one or more power sources. The method includes locally patterning a substrate disposed over a stage with the generated plasma by moving the stage with respect to the one or more point plasma sources.

In one embodiment, a three-dimensional plasma printing or processing system includes one or more point plasma sources. The system includes one or more power sources to generate plasma from a chemical precursor in the one or more point plasma sources. The system includes a stage to hold a substrate. The stage is tiltable, rotatable, and/or movable with respect to the one or more point plasma sources to direct radicals or ions from the plasma to locally pattern the substrate.

In one embodiment, a plasma source assembly includes one or more tubes for receiving chemical precursors. The plasma source assembly includes one or more RF power sources to generate plasma in the one or more tubes from the chemical precursors. Each of the one or more tubes has an aperture size that is smaller than the wavelength of the one or more RF power sources to direct radicals or ions from the generated plasma to locally pattern a sample disposed over a stage.

### BRIEF DESCRIPTION OF THE DRAWINGS

Embodiments of the present invention are illustrated by way of example, and not by way of limitation, and can be more fully understood with reference to the following detailed description when considered in connection with the figures in which:

FIG. 1 illustrates a system to perform three-dimensional printing and/or processing with plasma sources, in accordance with an embodiment of the present invention.

FIG. 2 illustrates a system with multiple point plasma sources and a movable stage, in accordance with an embodiment of the present invention.

FIG. 3 is a flow diagram of a method of three-dimensional plasma printing or processing, in accordance with an embodiment of the present invention.

FIG. 4A illustrates a point plasma source assembly with coaxial resonating plasma sources, in accordance with an embodiment of the present invention.

FIG. 4B illustrates a point plasma source assembly with folded coaxial plasma sources, in accordance with an embodiment of the present invention.

FIG. 4C illustrates a point plasma source assembly with radial transmission line based small aperture plasma sources, in accordance with an embodiment of the present invention.

FIG. 4D illustrates a point plasma source assembly with inductively coupled toroidal loops, in accordance with an embodiment of the present invention.

FIGS. 5A, 5B, and 5C illustrate assemblies with a single power source driving multiple point plasma sources, in accordance with an embodiment of the present invention.

FIG. 6 illustrates a radial transmission line based small aperture source with a separate pumping channel, in accordance with an embodiment of the present invention.

FIG. 7 illustrates a block diagram of an exemplary computer system within which a set of instructions, for causing the computer system to perform any one or more of the methodologies discussed herein, may be executed.

### DETAILED DESCRIPTION

Apparatuses, systems, and methods of three-dimensional printing and processing with plasma sources are described. According to one embodiment, a system includes one or more point plasma sources coupled with a moving stage to fabricate three-dimensional devices, perform die-by-die semiconductor processing, or perform three-dimensional printing. A system may perform three-dimensional printing of semiconductor or non-semiconductor materials using layer-by-layer processing which includes deposition and/or removal of materials, and/or surface chemical modification.

According to one embodiment, a plasma chamber includes point plasma source(s) and a stage which move relative to each other. For example, in one embodiment, the stage can move transversely and/or vertically, rotate, and/or tilt. The point source(s) can be variously angled with respect to the vertical axis. In one embodiment, the point plasma source(s) can move transversely and/or vertically, rotate, and/or tilt.

In one embodiment, the point source(s) can run multiple chemistries either sequentially or simultaneously (e.g., having some overlap in time). In contrast to existing plasma processing technologies which subject an entire substrate to chemistries generated by large plasma sources that run a single set of chemistry at any one time, embodiments of the invention enable fine control and precision using point plasma sources and a moving stage.

In the following description, numerous specific details are set forth, such as specific plasma treatments, in order to provide a thorough understanding of embodiments of the present invention. It will be apparent to one skilled in the art that embodiments of the present invention may be practiced without these specific details. In other instances, well-known aspects, such as chemical precursors for generating plasma, are not described in detail in order to not unnecessarily obscure embodiments of the present invention. Furthermore, it is to be understood that the various embodiments shown in the Figures are illustrative representations and are not necessarily drawn to scale.

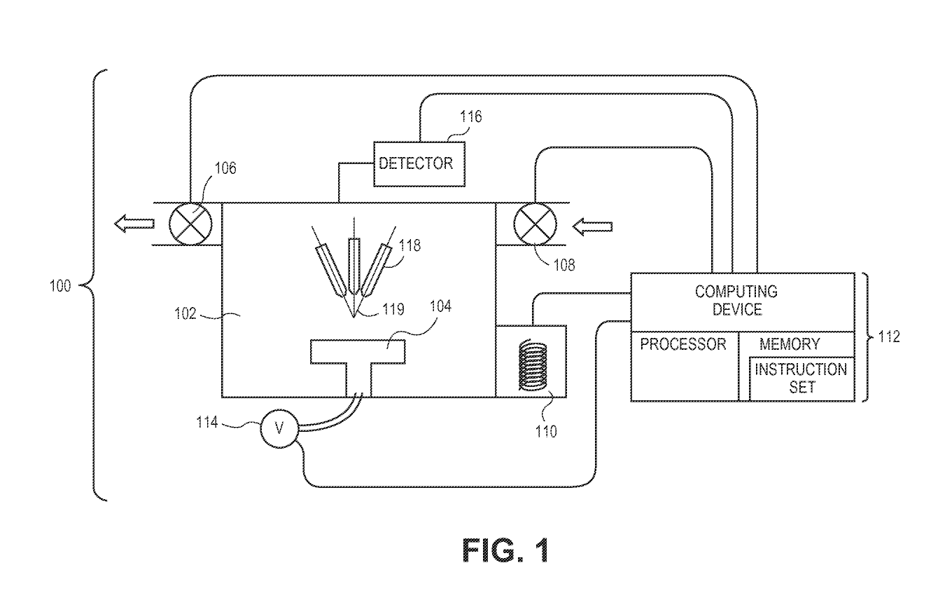

FIG. 1 illustrates a system to perform three-dimensional printing and/or processing with plasma sources, in accordance with an embodiment of the present invention.

The system 100 for performing 3D plasma printing or processing includes a chamber 102 equipped with a sample holder 104 (also referred to as a stage). The chamber 102 may include a reaction chamber suitable to contain an ionized gas, e.g., a plasma. The stage 104 can be a positioning device to bring a substrate (e.g., a semiconductor wafer, or other workpiece being processed), in proximity to the locally directed ionized gas or charged species ejected from one or more point plasma sources 118. A “point plasma source” is a plasma source capable of dispensing or directing plasma to a local area of the stage or substrate supported by the stage, in contrast to plasma sources and chambers which subject an entire substrate to plasma processing with a single chemistry at once.

The one or more point plasma sources 118 are coupled to or comprise a printing head, which enables creating chemistries at high electron temperatures while a substrate disposed on the stage 104 is at a substantially lower temperature than the plasma. For example, the point plasma sources 118 can generate plasma at temperatures of 0.5-5 eV, while the stage 104 is at room temperature, or at an elevated temperature (e.g., due to heating by a heater, for example) that is substantially lower than the plasma temperature. Thus, using the point plasma sources 118 to perform three-dimensional processing and printing enables maintenance of two different temperatures: the chemistry for performing the processing or printing is at a very high temperature necessary to create the radical or ionized species, and the stage 104 or sample held by the stage is at a lower temperature. Maintaining two different temperatures further enables processing and printing with a mixture of different elements and the creation of different types of alloys (e.g., metals, dielectrics, etc.).

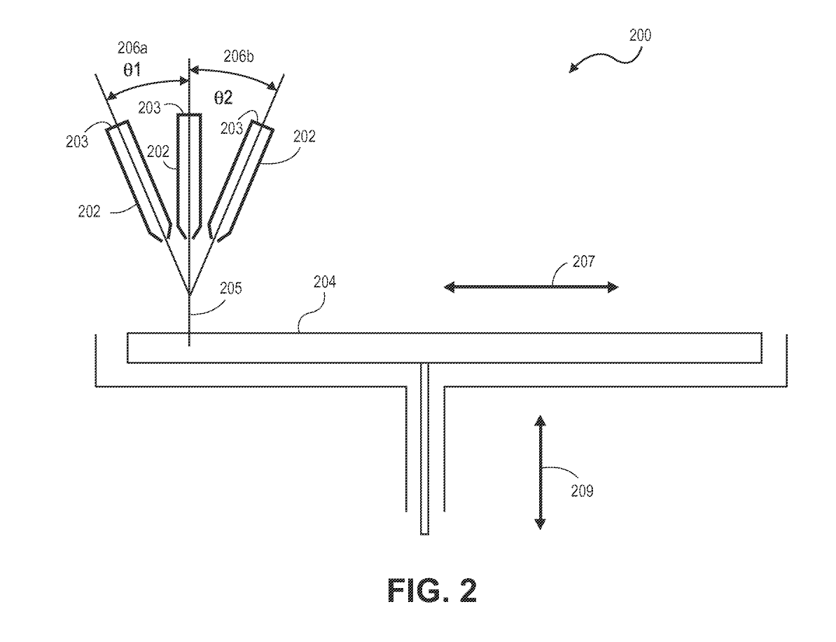

Exemplary precursors include tetraethyl orthosilicate (TEOS) for SiO₂ deposition, hexamethyldisilizane (HMDS) along with NH₃ to deposit silicon nitride or silicon carbonitride, and other organosilanes to deposit oxides, nitrides or carbides of silicon. Similarly, metallorganic precursors could be used such as, for example, Cu(hfac)₂ or other metal (hfac) or (acac) based chemistries introduced along with H₂ for metal deposition, or O₂, N₂ for ceramic deposition. Other examples of metals that the point plasma sources 118 can deposit include Al, Zr, Hf, Ti, Co, and their oxides or nitrides. In one embodiment, vapors of such elements could be delivered to the point plasma sources 118 from bubblers using an inert carrier gas such as helium or argon. These are examples of precursors and materials that the point plasma sources can deposit in embodiments, but other embodiments may include point plasma sources for depositing additional or different materials. Examples of point plasma sources are described in further detail below with reference to FIGS. 2, 4A-4D, 5A-5C, and 6.

The stage 104 and/or the point plasma source(s) 118 may be movable, tiltable, and/or rotatable. Moving the relative positions of the stage with respect to the point plasma source(s) laterally, vertically, and/or at an angle enables three-dimensional structures to be built locally layer-by-layer. Other embodiments may include multiple stages. In an embodiment in which the chamber 102 includes multiple stages, the multiple stages may all move, tilt, and or rotate to enable assembly line style plasma processing. In one embodiment, the point plasma source(s) 118 have adjustable angles, and the stage 104 moves laterally and/or vertically.

The system 100 can also include an evacuation device 106, a gas inlet device 108, and a plasma ignition device 110 coupled with the chamber 102. The gas inlet device 108, and plasma ignition device 110 can enable other forms of plasma processing in the chamber 102 apart from plasma processing with the point plasma sources 118. The evacuation device 106 may be a device suitable to evacuate and de-pressurize chamber 102. The gas inlet device 108 may be a device suitable to inject a reaction gas into chamber 102. The plasma ignition device 110 may be a device suitable for igniting a plasma derived from the reaction gas injected into chamber 102 by gas inlet device 108. The detection device 116 may be a device suitable to detect an end-point of a processing operation. In one embodiment, the system 100 includes a chamber 102, a stage 104, an evacuation device 106, a gas inlet device 108, a plasma ignition device 110, and a detector 116 similar to, or the same as, an etch chamber or related chambers. One such exemplary system includes an Applied Materials® AdvantEdge system.

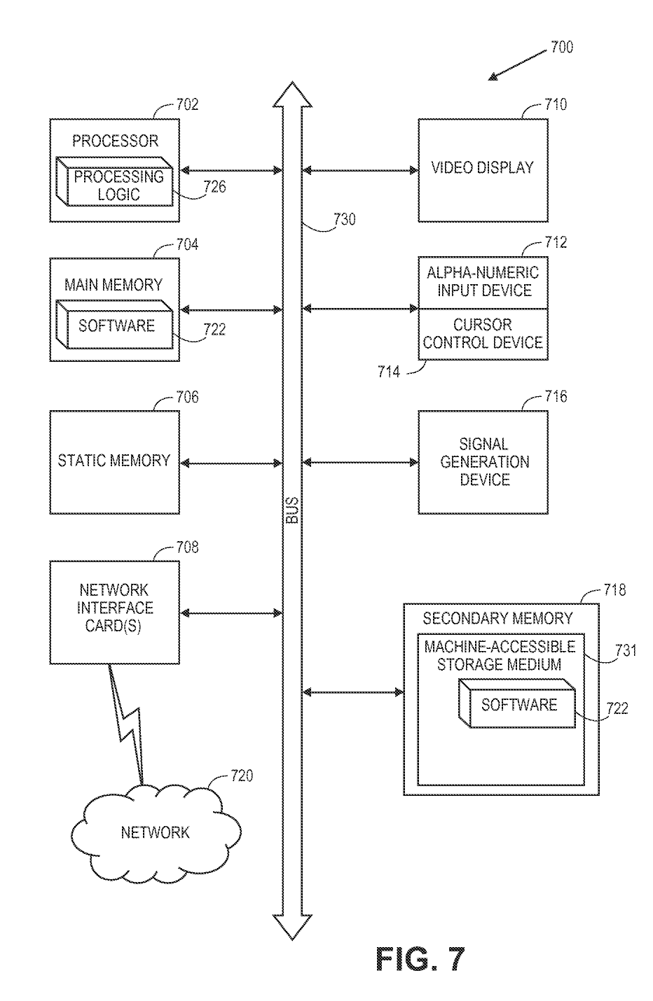

A computing device 112 is coupled with the point plasma source(s) 118 and the moveable stage 104. The illustrated computing device 112 includes memory, an instruction set, and a processor for executing instructions to perform methods described herein. The computing device can include features such as the computing device 700 of FIG. 7, or can be any other suitable computing device for carrying out methods described herein.

The computing device 112 can control process parameters for the point plasma source(s) 118 and/or movement and orientation of the moveable stage 104 and point plasma source(s) 118. For example, the computing device 112 can control the location and orientation of the point plasma sources 118 and the stage 104 with respect to each other at a given time during processing. In another example, the computing device 112 can control the aperture size of the point plasma source(s) 118 to dispense droplets of the desired size or a stream of plasma. The computing device 112 can also control other process parameters described herein. In an embodiment with a plasma ignition device 110, the computing device 112 is also coupled to the plasma ignition device 110. System 100 may additionally include a voltage source 114 coupled with stage 104 and a detector 116 coupled with chamber 102. Computing device 112 may also be coupled with evacuation device 106, gas inlet device 108, voltage source 114, and detector 116, as depicted in FIG. 1.

Thus, the system 100 of FIG. 1 illustrates an example of a system for performing 3D printing or processing with point plasma sources. The following description includes examples of a moveable stage and point plasma sources.

FIG. 2 illustrates a system with multiple point plasma sources and a movable stage, in accordance with an embodiment of the present invention. The system 200 includes one or more point plasma sources 202. In the embodiment illustrated in FIG. 2, the point plasma sources 202 are small aperture plasma sources at varied angles 206a and 206b with respect to the vertical axis (i.e., a vertical axis with respect to a sample holding stage 204). In one embodiment, the point plasma sources 202 can move vertically and/or laterally with respect to the stage 204. According to one embodiment, the point plasma sources 202 can operate in pressure ranges from 1 or more mTorr to atmospheric pressures (e.g., 760 Torr).

According to one embodiment, the system 200 delivers chemical precursors (e.g., chemical precursors in the form of a vapor, gas, and/or powder) to the point plasma sources 202 for deposition or etching of a sample held by the stage 204. The point plasma sources 202 produce highly reactive chemical radicals or ions 205 at elevated (e.g., away from equilibrium) temperatures. The produced radicals or ions are brought to react with a sample or be deposited on a surface of the stage 204, or a surface of a sample held by the stage 204. In one embodiment, the point plasma sources 202 are at ground potential, which enables introducing chemical precursors into the point plasma sources in a field free environment without the sources cracking or breaking down in other ways.

The stage 204 can hold a sample to be processed, or can receive a three-dimensional object to be printed. In one embodiment, the stage 204 can move laterally, vertically, rotate, and/or can be angled with respect to the vertical axis. Vertical movement of the stage is indicated by the arrow 209. Horizontal movement of the stage is indicated by the arrow 207. The stage 204 can include or support infrastructure such as cooling (e.g., backside helium, and/or a liquid cooled stage) and power delivery (e.g., DC, pulsed DC, or RF at low, medium, or high frequencies, at very high frequencies (VHF), or at microwave frequencies).

According to one embodiment, the system deposits and/or etches a sample using different radicals or ions. Different sources can activate different radicals or ions at the same time. For example, one of the point plasma sources 202 can activate one type of etch species while another of the plasma sources 202 is activating another type of etch species. The system can also (or alternatively) perform processing or printing sequentially, such that at any given time, the plasma sources 202 are activating the same etch species. In an embodiment with a single point plasma source, the plasma source can sequentially activate different species, and/or mix different chemistries together to deposit alloys.

Thus, one or more point plasma sources 202 can locally layer different materials by pulsing or switching chemical precursors. The point plasma sources move relative to the stage to locally deposit layers and/or etch a sample to generate thin films of different materials in patterns according to a model. The layer thickness depends on the deposition rate, which can be adjusted according to the model. In one example, a layer is a few hundred thousandths of angstroms. The system 200 then scans across the sample to deposit or process the next layer, which could be in a same or different location, and composed of the same or a different material. This process continues layer by layer until the system processes or prints a three-dimensional object.

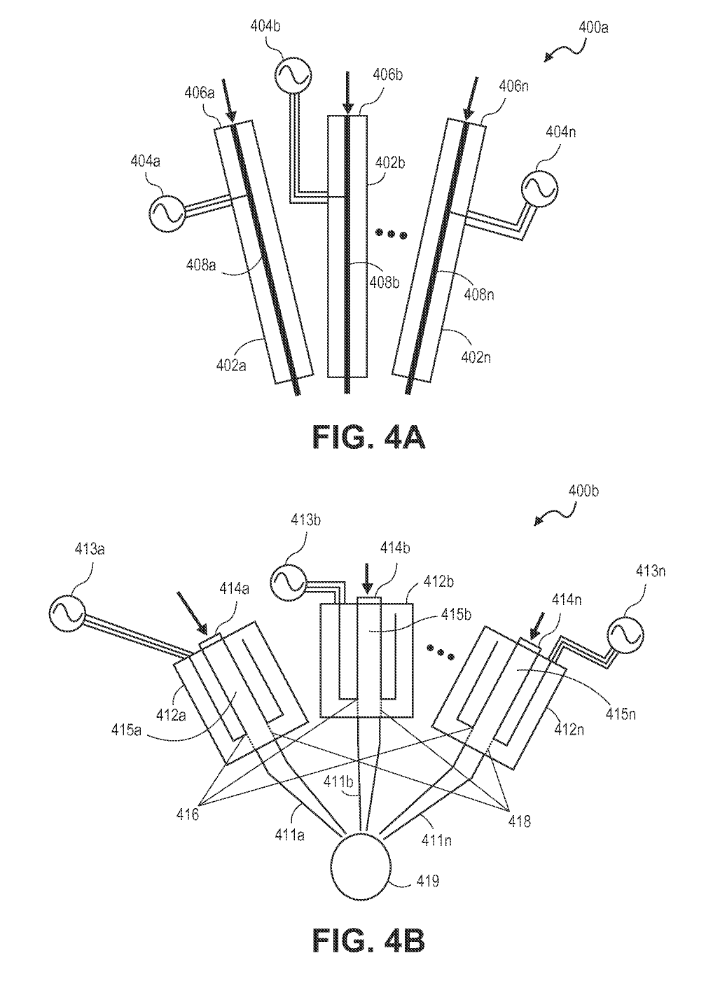

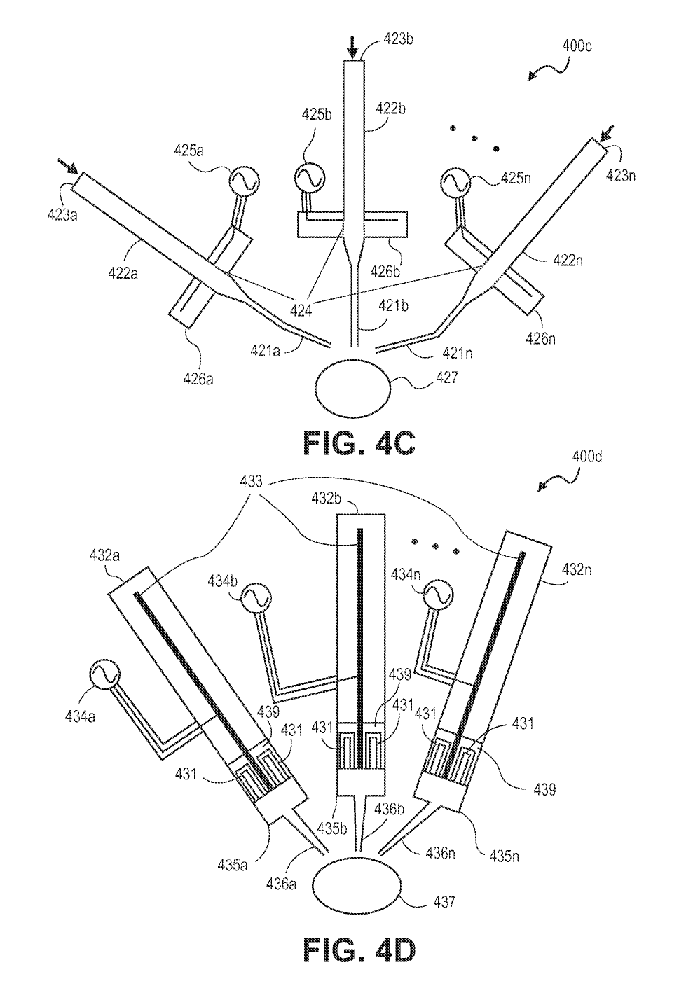

The point plasma sources 202 can include plasma sources such as those illustrated in FIGS. 4A-4D. Although FIG. 2 illustrates three point plasma sources, other embodiments can include one or more point plasma sources (e.g., 1, 2, 3, or N point plasma sources where N is a positive integer). According to embodiments, the point plasma sources 202 are smaller or scaled down in size in comparison to existing plasma sources. Small plasma sources can include small aperture sizes for directing radical or ionized species to a sample or the stage to perform local processing or printing. In one embodiment, plasma is generated in a larger volume (e.g., a tube), and dispensed through the small aperture.

The aperture size of the point plasma sources 202 can be small in relation to, for example, the wavelength of the supplied RF power source or the die size being printed or processed. The aperture “size” refers to the diameter of a circular aperture or the longest length or diameter of a non-circular aperture (e.g., the transverse diameter of an oval-shaped aperture). According to one embodiment, the wavelength depends on the spatial extent of the plasma zone. For example, in one embodiment with point plasma sources, the RF frequency is 30 GHz, and the wavelength is 1 cm. In one such embodiment, the aperture of the source would be at least as small as 0.75 to 0.5 times the size of the wavelength. Therefore, for a wavelength of 1 cm, the aperture size is less than or equal to 0.5 cm, according to an embodiment. In one such embodiment, the aperture size is in a range of 0.25 cm and 0.5 cm.

The aperture size can also be determined according to the size of the die being processed or printed. In one such embodiment, the aperture of the point plasma source is smaller than a die being processed or printed on a substrate. For example, the aperture of the point plasma source has a diameter that is shorter than the longest length of the die being processed or printed. In one embodiment, the aperture size is in a range of 100-1000 μm. In one such embodiment, the aperture size is in a range of 100-500 μm. According to an embodiment, the system 200 can adjust the aperture size of the point plasma sources 202 to enable patterning the substrate with a larger or smaller plasma stream. The system 200 can adjust the aperture size during plasma processing to process areas of different sizes, according to an embodiment.

In one embodiment, the point plasma sources operate in the VHF (e.g., greater than or equal to 40 MHz) and microwave (e.g., 650 MHz) ranges. In one embodiment, the point plasma sources can operate in frequencies lower than the microwave range, but still operate in small physical spaces, by loading the assembly structures with materials having a high dielectric constant (e.g., greater than 2) and with other slow wave structures. Other slow wave structures can include, for example, distributed periodic discs, center conductors which are helically wound, and other suitable structures.

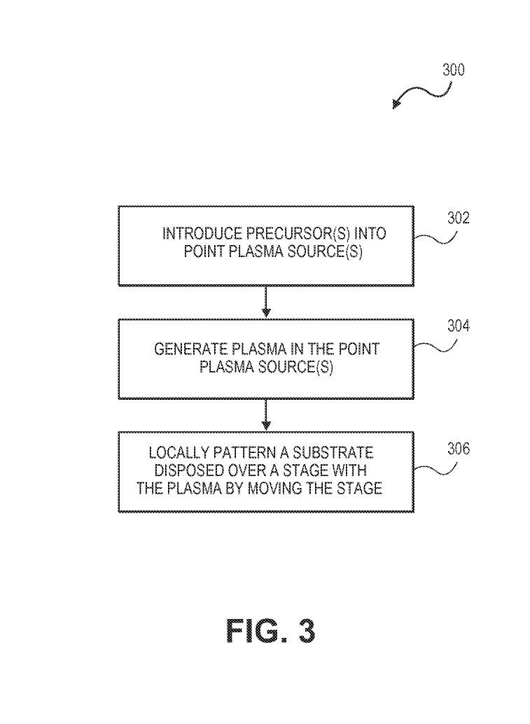

FIG. 3 is a flow diagram of a method of three-dimensional plasma printing or processing, according to an embodiment. The system 100 of FIG. 1 and the system 200 of FIG. 2 are examples of systems to perform the method 300 of FIG. 3.

At operation 302, a system introduces one or more precursors into one or more point plasma sources. According to embodiments, the system introduces a chemical precursor into the tube of one or more of the point plasma sources. For example, the system 200 of FIG. 2 introduces a gas into one end 203 of a tube of the point plasma sources 202. In one embodiment, the system introduces multiple chemical precursors into the point plasma source(s). In one such embodiment, the system 200 can introduce multiple chemical precursors sequentially or simultaneously. Sequential introduction of different chemical precursors into the point plasma source(s) can generate layers of different materials on the substrate. Simultaneous introduction of different chemical precursors into the point plasma source(s) can enable mixing chemistries on the substrate, or generating a layer on the substrate that includes multiple different materials.

At operation 304, the system generates plasma in the point plasma source(s). For example, the system 200 of FIG. 2 applies power to generate plasma in the tube of the point plasma source(s) 202 into which the precursor was introduced. At operation 306, the system locally patterns a substrate disposed over a stage with the plasma by moving the stage. For example, radicals or ions from the generated plasma are directed to a substrate supported by the stage 204 (or to the stage 204) to perform three-dimensional processing or printing. The system 200 moves the stage 204 with respect to the point plasma sources 202 to pattern different parts of the substrate. Moving the stage with respect to the point plasma sources can include one or more of: moving the stage horizontally, moving the stage vertically, rotating the stage, and tilting the stage with respect to the one or more point plasma sources.

The system can also move the point plasma source(s) with respect to the stage. Moving the one or more point plasma sources with respect to the stage can include one or more of: moving the one or more point plasma sources horizontally, moving the stage vertically, rotating the stage, and tilting the stage with respect to the point plasma source(s). In one embodiment, the system can adjust the aperture size of the point plasma source(s) to pattern one area of the substrate with a smaller stream of plasma than another area of the substrate. For example, the system can adjust the aperture size of the point plasma source(s) in the range of 0.1 to 1 cm.

Locally patterning the substrate can include, for example, etching, depositing, and/or modifying chemical surface properties of the substrate. Modifying chemical surface properties of the substrate can include, for example, localized plasma assisted surface functionalization such as hydrogenation, hydroxylation, chlorination, fluorination, silylation, and other surface property modification. Surface property modifications may enable selective deposition, etch, or other subsequent chemical transformation of the substrate.

FIGS. 4A-4D, 5A-5C, and 6 illustrate examples of point plasma sources, such as the point plasma sources 118 of FIG. 1 and the point plasma sources 202 of FIG. 2.

FIG. 4A illustrates a point plasma source assembly with coaxial resonating plasma sources, in accordance with an embodiment of the present invention. The point plasma source assembly 400a includes N coaxial resonating plasma sources 402a-402n. Chemical precursors are introduced into the ends 406a-406n of tubes 408a-408n or columns of the point plasma sources 402a-402n. A coaxial resonator can be a transmission line resonator which is short on one side, and open on the other side. For example, the coaxial resonators of the point plasma sources 402a-402n can be open on the end near the aperture from which plasma is dispensed, and short on the opposite end into which the chemical precursors are brought in. In the illustrated embodiment, the ends 406a-406n of the resonators are short. A transmission line that is short on one side has an inner and outer conductor which join. In a point plasma source including a coaxial resonator, high voltages are generated on the open side with one or more power sources 404a-404n to generate a plasma torch using chemical precursors.

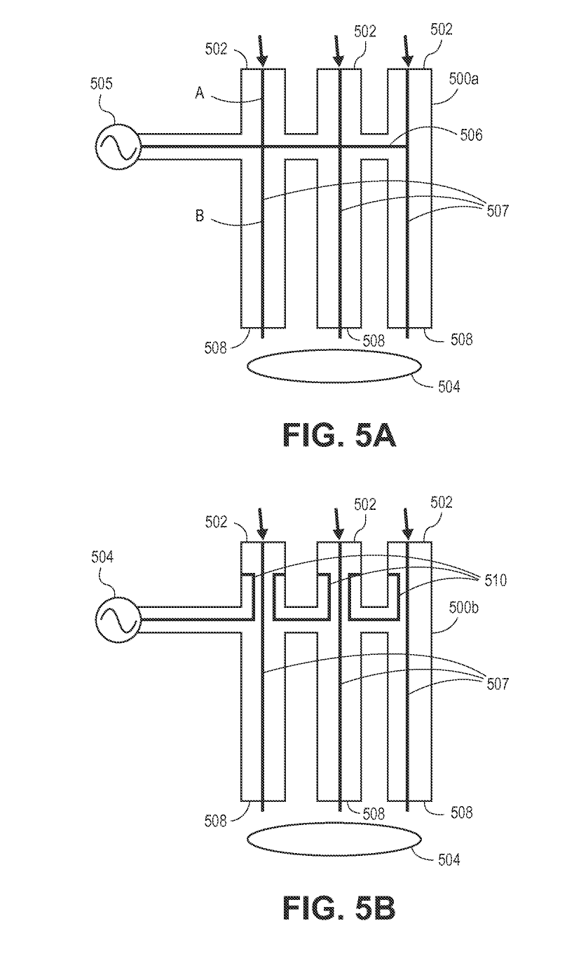

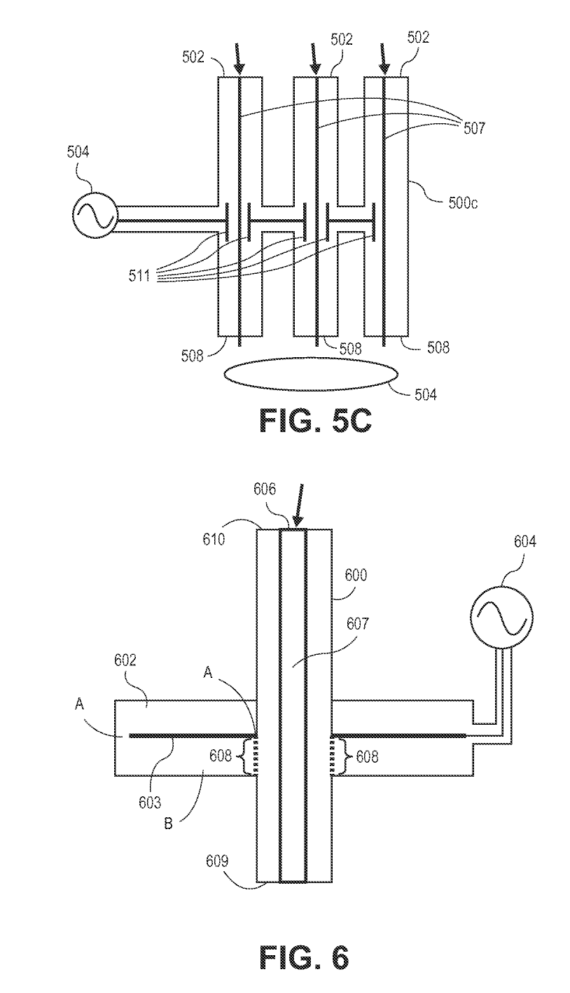

FIG. 4B illustrates a point plasma source assembly with folded coaxial plasma sources, in accordance with an embodiment of the present invention. The point plasma source assembly 400b of FIG. 4B includes N folded coaxial plasma sources 412a-412n. The coaxial structure is a convenient and symmetrical structure for delivering RF power. One advantage of a coaxial structure, in one embodiment, is the fact that the electromagnetic energy is confined in the annular space between the inner and outer conductor. Therefore, as a means to deliver power to the plasma, the facilities such as gas lines and coolant lines can be brought within the inner conductor with a low risk of electromagnetic interference or gas breakdown in the gas lines. However, there is a practical problem with the physical size when using a coaxial structure for the lower frequency VHF sources, according to an embodiment. As an example, the wavelength at 60 MHz is 5 m. A length of 5 m may be impractical for point plasma sources. In order to realize the same electrical length in a much smaller physical length, the structure can be folded where the inner conductor wraps around the outer conductor and the roles are swapped. The inner now becomes the outer and the outer conductor becomes the inner conductor. This arrangement still preserves the coaxial symmetry. Similar to the plasma sources in FIG. 4A, the system introduces chemical precursors into ends 414a-414n of tubes 415a-415n or columns of the folded coaxial plasma sources 412a-412n. One or more power sources 413a-413n activate radicals or ions in the tube or column, which are output at the other end to generate plasma 419. In one embodiment, each of the plasma sources 412a-412n has a dielectric window 418 for coupling energy, which is further explained below with reference to FIGS. 5A-5C. The point plasma sources 412a-412n include small apertures 411a-411n for dispensing plasma 419 for 3D processing and printing.

FIG. 4C illustrates a point plasma source assembly 400c with N radial transmission line based small aperture plasma sources 422a-422n, in accordance with an embodiment of the present invention. Chemical precursors are introduced into the ends 423a-423n of the point plasma sources 422a-422n. According to the embodiment illustrated in FIG. 4C, one or more power sources 425a-425n supply power (e.g., RF power) radially using radial transmission lines 426a-426n to generate plasma 427. Because power is supplied radially, a greater portion of the tubes are available for receiving chemical precursors. Thus, in one embodiment, a small aperture radial resonator point plasma source can receive a greater quantity of chemical precursors into its tube than small aperture plasma sources with a coaxial resonator. Similar to the point plasma sources in FIG. 4B, in one embodiment, radial transmission line point plasma sources can include windows 424 for coupling energy. The point plasma sources 422a-422n include small apertures 421a-421n for dispensing plasma 427 for 3D processing and printing.

FIG. 4D illustrates a point plasma source assembly 400d with inductively coupled toroidal loops, in accordance with an embodiment of the present invention. In one embodiment, the plasma sources 432a-432n generate plasma 437 using the inductively coupled toroidal loops threaded by a magnetic field generated near the short end due to high currents. Typically, coaxial resonators are used to generate plasma in the open ends 433. Unlike typical coaxial resonators, the coaxial resonators in the illustrated embodiment are used to generate plasma at the shorted end. As illustrated, the short inner conductor of the plasma sources 432a-432n is connected to the outer conductor. In one such embodiment, the system supplies power with power sources 434a-434n to generate plasma 437 in the U-shaped toroidal tubes 431. The plasma current closes the loop in the bottom 435a-435n where the precursor is introduced. In the embodiment illustrated in FIG. 4D, the point plasma sources 432a-432n include dielectric plugs 439 with the U-shaped toroidal tubes 431 (e.g., channels) that are azimuthally arranged and open at the bottom. In the example illustrated in FIG. 4D, the chemical precursors are introduced on a side of the plasma source near the end 435a-435n of the tube from which radicals or ions are ejected. The point plasma sources 432a-432n include small apertures 436a-436n.

In embodiments, the above described transmission line based distributed plasma sources illustrated in FIGS. 4A-4D can include features such as: electrodes at DC potential, sheath voltages resulting from bombardment of chamber surfaces which are very low (e.g., at 162 MHz around 1000 W of source power, the sheath voltages are less than 30 V RMS), and/or assemblies which enable precursors to be introduced in an electromagnetic free manner. The transmission line based distributed structures include a distributed inductor which either resonates or is close to resonance with a distributed capacitor, and the plasma has an impedance that loads the Q “quality” factor of the resonant or near-resonant structures.

FIGS. 5A, 5B, and 5C illustrate assemblies with a single power source 505 (generator) driving multiple point plasma sources, in accordance with an embodiment of the present invention. In embodiments illustrated in FIGS. 5A-5C, energy from one resonating structure is coupled to a second resonating structure. Energy can be coupled to another resonating structure with, for example, a physical tap connection, through inductive pickups, capacitive pickups, or through any other means of coupling energy between resonating structures.

For example, FIG. 5A illustrates point plasma sources 500a with a tapped matching scheme. The embodiment illustrated in FIG. 5A includes three coaxial resonators, although other embodiments can include two or more coaxial resonators. The coaxial resonators have inner conductors 507 that are electrically connected to the outer conductor at one end (e.g., the short end with high current and low voltage) and open on the other end. The generator 505 powers the first coaxial resonator using a tapped inductor where the generator RF hot lead is physically connected to the inner conductor of the first coaxial resonator. The physical connection 506 to the first resonator divides the coaxial resonator into two regions, labeled A and B. The region A has stored magnetic energy. The region B has stored electrical energy. In one embodiment, the physical connection 506 on the inner conductor of the coaxial resonator from the generator 505 is located such that the region A and/or the region B is smaller than the quarter wavelength. The region A, which has a short on one end and which stores magnetic energy, can be considered an inductor when the length is smaller than the quarter wavelength, according to an embodiment. The region B, which has an open on one end and which stores electrical energy, can considered a capacitor when the length is smaller than the quarter wavelength, according to an embodiment. In one such embodiment, the coaxial resonator forms an “LC” type of resonance. Energy from the first resonator is fed into the second coaxial resonator, and then from the second to the third resonator.

FIG. 5B illustrates point plasma sources 500b with an inductively coupled matching scheme. The coaxial resonators in the embodiment illustrated in FIG. 5B have inductive loops 510 for feeding energy into the coaxial resonators. In one embodiment, the inductive loops 510 are located in a section where current can be driven into the system. This in turn generates a magnetic field, and a changing magnetic field in turn generates an electric field. Energy from the first resonator is thus fed into the second resonator with the inductive loops, and similarly from the second resonator into the third resonator.

FIG. 5C illustrates point plasma sources 500c with a capacitively coupled matching scheme. The system introduces precursors into ends 502 of the point plasma sources, applies power from the single power source 505 to generate plasma 504 from ends 508. According to one embodiment, an electric field is established between the electrodes 511 and the inner conductors 507. The time varying electric field generates a time varying magnetic field, and resonance is set up in the resonators. Thus, energy is transferred from the first resonator to the second resonator, and from the second resonator to the third resonator.

FIG. 6 illustrates a radial transmission line based small aperture source with a separate pumping channel, in accordance with an embodiment of the present invention.

The point plasma source illustrated in FIG. 6 has a folded radial transmission line resonator 602 with an inner conductor 603. According to one embodiment, the folded radial transmission line resonator 602 has three regions. The regions A represent two folded radial transmission line source regions where magnetic energy is stored. The region B represents a region where electric energy is stored. In one embodiment, unlike in coaxial systems where the impedance is fixed, the impedance in the illustrated embodiment is a function of the radius. In one embodiment, a pump is connected to the source assembly 600 at the end 610 to pump out species for three-dimensional processing or printing. In the illustrated embodiment, the pump is connected adjacent to a precursor duct 606. According to one embodiment, the pump pumps byproducts through the individual point sources to reduce cross contamination between sources. In one such embodiment, sources can accept chemical precursors through the precursor duct 606, generate plasma with the power source 604, and pump out the generated species from the other end 609. For example, a point plasma source with a coaxial structure can receive chemical precursors through the precursor duct 606 and into a center region 607. Plasma is located in the annular region between the center region 607 and the outer wall. The point plasma source then pumps out the generated species through the annular region between an inner and an outer conductor. Thus, in one embodiment, the system is self-contained and the lifetime of the species in the plasma region can be controlled near the end 609. The plasma point source 600 can include a dielectric window 608 for coupling energy as explained above.

The plasma generated by the point plasma sources illustrated in FIGS. 4A-4D, 5A-5C and 6 can be used to deposit or remove materials of a substrate to perform 3D processing and printing.

FIG. 7 illustrates a computer system 700 within which a set of instructions, for causing the machine to execute one or more of the scribing methods discussed herein may be executed. The exemplary computer system 700 includes a processor 702, a main memory 704 (e.g., read-only memory (ROM), flash memory, dynamic random access memory (DRAM) such as synchronous DRAM (SDRAM) or Rambus DRAM (RDRAM), etc.), a static memory 706 (e.g., flash memory, static random access memory (SRAM), etc.), and a secondary memory 718 (e.g., a data storage device), which communicate with each other via a bus 730.

Processor 702 represents one or more general-purpose processing devices such as a microprocessor, central processing unit, or the like. More particularly, the processor 702 may be a complex instruction set computing (CISC) microprocessor, reduced instruction set computing (RISC) microprocessor, very long instruction word (VLIW) microprocessor, etc. Processor 702 may also be one or more special-purpose processing devices such as an application specific integrated circuit (ASIC), a field programmable gate array (FPGA), a digital signal processor (DSP), network processor, or the like. Processor 702 is configured to execute the processing logic 726 for performing the operations and steps discussed herein.

The computer system 700 may further include a network interface device 708. The computer system 700 also may include a video display unit 710 (e.g., a liquid crystal display (LCD) or a cathode ray tube (CRT)), an alphanumeric input device 712 (e.g., a keyboard), a cursor control device 714 (e.g., a mouse), and a signal generation device 716 (e.g., a speaker).

The secondary memory 718 may include a machine-accessible storage medium (or more specifically a computer-readable storage medium) 731 on which is stored one or more sets of instructions (e.g., software 722) embodying any one or more of the methodologies or functions described herein. The software 722 may also reside, completely or at least partially, within the main memory 704 and/or within the processor 702 during execution thereof by the computer system 700, the main memory 704 and the processor 702 also constituting machine-readable storage media. The software 722 may further be transmitted or received over a network 720 via the network interface device 708.

While the machine-accessible storage medium 731 is shown in an exemplary embodiment to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine to perform any one or more of the methodologies of the present invention.

For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), a machine (e.g., computer) readable transmission medium (electrical, optical, acoustical or other form of propagated signals (e.g., infrared signals, digital signals, etc.)), etc.

Thus, systems, apparatuses, and method of three-dimensional processing or printing are described. Methods can involve creating plasma by introducing chemical precursors to point plasma sources. The method can include subjecting a system with a stage and multi-aperture sources to relative motion in a controlled manner to enable building structures on a per-die basis or to create larger three-dimensional structures using layer-by-layer deposition and processing guided by cross sectional digital models (e.g., CAD drawings). The stage and/or samples held by the stage can be heated, cooled, or otherwise subject to alternative sources of energy. The described methods can enable local processing, which can be beneficial for rectifying issues on a die-by-die basis. Examples of three-dimensional processing and printing include local etching, deposition of different materials and of differing amounts/thicknesses, curing (e.g., adjusting quality of a photoresist locally to have different selectivity), or a combination thereof. Such methods can also use less power and chemical precursors than conventional approaches.

It is to be understood that the above description is intended to be illustrative, and not restrictive. For example, while flow diagrams in the figures show a particular order of operations performed by certain embodiments of the invention, it should be understood that such order is not required (e.g., alternative embodiments may perform the operations in a different order, combine certain operations, overlap certain operations, etc.). Furthermore, many other embodiments will be apparent to those of skill in the art upon reading and understanding the above description. Although the present invention has been described with reference to specific exemplary embodiments, it will be recognized that the invention is not limited to the embodiments described, but can be practiced with modification and alteration within the spirit and scope of the appended claims. The scope of the invention should, therefore, be determined with reference to the appended claims, along with the full scope of equivalents to which such claims are entitled.

What is claimed is:

1. A method of three-dimensional plasma printing or processing, the method comprising:
introducing chemical precursors into one or more point plasma sources;
generating plasma in the one or more point plasma sources from the chemical precursors with one or more power sources;
locally patterning a substrate disposed over a stage with the generated plasma by moving the stage with respect to the one or more point plasma sources.

2. The method of claim 1, wherein moving the stage with respect to the one or more point plasma sources comprises one or more of:
moving the stage horizontally, moving the stage vertically, rotating the stage, and tilting the stage with respect to the one or more point plasma sources.

3. The method of claim 1, further comprising:
moving the one or more point plasma sources with respect to the stage.

4. The method of claim 3, wherein moving the one or more point plasma sources with respect to the stage comprises one or more of:
moving the one or more point plasma sources horizontally, moving the stage vertically, rotating the stage, and tilting the stage with respect to the one or more point plasma sources.

5. The method of claim 1, further comprising:
sequentially introducing different chemical precursors into the one or more point plasma sources to generate layers of different materials on the substrate.

6. The method of claim 1, further comprising:
simultaneously introducing a chemical precursor into one of the one or more point plasma sources and a different chemical precursor into another of the one or more point plasma sources to generate a layer comprising different materials on the substrate.

7. The method of claim 1, wherein each of the one or more point plasma sources comprises a coaxial resonating plasma source.

8. The method of claim 1, wherein each of the one or more point plasma sources comprises a folded coaxial plasma source.

9. The method of claim 1, wherein each of the one or more point plasma sources comprises a radial transmission line based small aperture plasma sources.

10. The method of claim 1, wherein each of the one or more point plasma sources comprises inductively coupled toroidal loops.

11. The method of claim 1, wherein generating the plasma in the one or more point plasma sources comprises:
generating the plasma in a plurality of point plasma sources with a power source, driving a first of the plurality of point plasma sources with the power source and coupling energy to the other point plasma sources via dielectric windows.

12. The method of claim 1, wherein locally patterning the substrate further comprises adjusting an aperture size of the one or more point plasma sources to pattern one area of the substrate with a smaller stream of plasma than another area of the substrate.

13. The method of claim 12, wherein the aperture size of the one or more point plasma sources is in a range of 0.1 to 1 cm.

14. The method of claim 1, wherein locally patterning the substrate further comprises modifying chemical surface properties of the substrate.

15. A three-dimensional plasma printing or processing system comprising:
one or more point plasma sources;
one or more power sources to generate plasma from a chemical precursor in the one or more point plasma sources;
a stage to hold a substrate, wherein the stage is tiltable, rotatable, and/or movable with respect to the one or more point plasma sources to direct radicals or ions from the plasma to locally pattern the substrate.

16. The system of claim 15, wherein the one or more point plasma sources are tiltable, rotatable, and/or movable with respect to the stage.

17. The system of claim 15, wherein:
the one or more point plasma sources is configured to introduce different chemical precursors to generate layers of different materials on the substrate.

18. The system of claim 15, wherein:
one chemical precursor is introduced into one of the one or more point plasma sources simultaneously with a different chemical precursor into another of the one or more point plasma sources.

19. A plasma source assembly comprising:
one or more tubes configured to receive chemical precursors; and
one or more RF power sources configured to generate plasma in the one or more tubes from the chemical precursors;
wherein each of the one or more tubes has an aperture size that is smaller than a wavelength of the one or more RF power sources to direct radicals or ions from the generated plasma to locally pattern a sample disposed over a stage.

20. The plasma source assembly of claim 19, wherein the aperture size is between 0.1 cm and 1 cm.
